(19) United States
(12) Patent Application Publication
(10) Pub. No.: US 2026/0088548 A1
(43) Pub. Date: Mar. 26, 2026

(54) POGO PIN INTERFACE APPARATUS WITH PIN PRESSURE ADJUSTMENT DEVICE

(71) Applicant: Chien Wen Chang, Taoyuan City (TW)

(72) Inventor: Chien Wen Chang, Taoyuan City (TW)

(21) Appl. No.: 19/330,652

(22) Filed: Sep. 16, 2025

(30) Foreign Application Priority Data
Sep. 20, 2024 (TW) 113135766

(51) Int. Cl. H01R 13/193; H01R 13/24; H01R 101/00; H01R 103/00; H01R 107/00

(52) U.S. Cl. CPC H01R 13/193; H01R 13/2421; H01R 13/2471; H01R 2101/00; H01R 2103/00; H01R 2107/00

(57) ABSTRACT

A pogo pin interface apparatus with pin pressure adjustment device includes a housing; a pogo pin disposed in the housing, an insulation member disposed on the pogo pin; and a pin pressure adjustment device disposed on the housing and including an adjustment knob including a port at one end, a contact terminal disposed under the port and electrically connected to the port, one end of the pogo pin being in contact with the contact terminal to be electrically connected together, and a threaded section formed on an outer surface of the adjustment knob; and a knob mounting seat comprising at least one threaded hole secured to the threaded section. A rotation of the adjustment knob is configured to adjust a distance of the adjustment knob relative to the knob mounting seat.

### FIELD OF THE INVENTION

The invention relates to pogo pins and more particularly to a pogo pin interface apparatus with pin pressure adjustment device for an automatic test system, such pogo pin interface apparatus is mainly used for electrically connecting to a probe card, the pogo pin interface apparatus including a pin pressure adjustment device so that the pogo pin interface apparatus has advantages of being capable of flexibly adjusting a pin pressure of each pogo pin or a projecting length of the pogo pin relative to the housing, besides, the invention is capable of allowing a user to replace the pogo pin with a new one that has a different diameter if necessary, and being more adaptable to meet requirements of different test applications.

### BACKGROUND OF THE INVENTION

With the rapid development of the semiconductor industry, the demand for automatic test equipment increases greatly. Pogo pin interfaces have been widely used in automatic test systems. Conventional technologies have mostly focused on increasing pin density of the pogo pin interface, reducing contact resistance, increasing signal bandwidth, or reducing noise and crosstalk.

Referring to FIG. 31, it shows a conventional pogo pin interface 1 including a housing 101 and a plurality of pogo pins 102. The housing 101 is typically made of insulation material and provided with a plurality of mounting holes 105. The pogo pins 102 are disposed in the mounting holes 105 respectively. One end of each pogo pin 102 is electrically connected to an electrical cable 103 through a connector 104. However, the pogo pin interface 1 cannot flexibly adjust pin pressure characteristics of each pogo pin 102 or flexibly change the projecting length of each pogo pin 102 relative to the housing 101. It is only possible to adjust an overall relative distance between the pogo pin interface 1 and a mating object (e.g., a probe card) to increase or decrease the pin pressure of all the pogo pins 102. It is not possible to flexibly select specific pogo pins 102 to increase or decrease the pin pressure. Moreover, diameter of each pogo pin 102 used in this technology must strictly match the diameter of the mounting holes 105 of each housing 101. If the diameter of the pogo pin 102 must be changed in response to new application requirements, the housing 101 must be replaced with a new one which is redesigned and manufactured according to the required changes of the specifications of the mounting holes 105. This shows a great lack of adaptability.

Referring to FIG. 32, it shows another conventional pogo pin interface 2 comprising a housing 201 including a plurality of mounting holes 205 formed therethrough, a plurality of pogo pins 202, a plurality of pin sleeves 204, and a plurality of electrical cables 203. Each pin sleeve 204 is disposed in each mounting hole 205. Each pogo pin 202 is secured to the housing 201 through each pin sleeve 204. Each electrical cable 203 is electrically connected to an end of each pin sleeve 204 by soldering. If one pogo pin 202 malfunctions, it must be pulled downward using an appropriate tool and then replaced with a new one. This technique also does not allow a user to flexibly adjust the pin pressure of a specific pogo pin 202. While the pogo pin 202 can be replaced, the replacement is strictly limited by the diameters of the pin sleeve 204 and the corresponding mounting hole 205. Therefore, the replacement does not allow the user to replace a pogo pin 202 with a new one having a different diameter.

Referring to FIG. 33, it shows a conventional automatic test system 3. A test head 301 includes a pogo pin interface 302 disposed there below. The pogo pin interface 302 includes a plurality of pogo pins 304, besides, a probe card 303 disposed under the pogo pin interface 302. For adjusting the pin pressure, the height of the test head 301 is adjusted by operating a lift 305, which in turn changes the relative distance between the pogo pin interface 302 and the probe card 303. This method can change the degree of compression of an internal spring of each pogo pin 304, thereby varying the contact force (i.e., pin pressure) applied by each pogo pin 304 to the probe card 303. However, this adjustment method can only increase or decrease the pin pressure of all the pogo pins 304 as a whole. It does not allow for flexible adjustment of the pin pressure of a portion of the pogo pin 304 or a specific pogo pin 304.

As seen from above, the conventional technologies cannot flexibly adjust the pin pressure of the pogo pin interface, nor can it flexibly change pogo pins of different diameters. For different and changing testing requirements, the conventional pogo pin interfaces still have too many limitations which are disadvantageous to the flexible applications of the automatic test systems.

Thus, the need for improvement still exists.

### SUMMARY OF THE INVENTION

It is therefore a first object of the invention to provide a pogo pin interface apparatus with pin pressure adjustment device comprising a housing; at least one pogo pin disposed in the housing, a plunger at one end of the pogo pin or either end of the pogo pin, and an insulation member disposed on the pogo pin; and at least one pin pressure adjustment device disposed on the housing and comprising an adjustment knob including a port at one end, a contact terminal disposed under the port and electrically connected to the port, one end of the pogo pin being in contact with the contact terminal to be electrically connected together, and a threaded section formed on an outer surface of the adjustment knob at the other end of the adjustment knob; and a knob mounting seat comprising at least one threaded hole secured to the threaded section; wherein a rotation of the adjustment knob is configured to adjust a distance of the adjustment knob relative to the knob mounting seat.

It is a second object of the invention to provide a pogo pin interface apparatus with pin pressure adjustment device comprising a housing; at least one pogo pin disposed in the housing, a plunger at one end of the pogo pin or either end of the pogo pin, and an insulation member disposed on the pogo pin; and at least one pin pressure adjustment device disposed on the housing and comprising an adjustment knob including a port at one end, a contact terminal disposed under the port and electrically connected to the port, one end of the pogo pin being in contact with the contact terminal to be electrically connected together, and a threaded section formed on an outer surface of the adjustment knob at the other end of the adjustment knob; and a knob mounting seat comprising an integral tubular member which is at least partially disposed in the housing, and at least one threaded hole; wherein the insulation member is disposed in the tubular member through the threaded hole which is threadedly secured to the threaded section; and wherein a rotation of the adjustment knob is configured to adjust a distance of the adjustment knob relative to the knob mounting seat.

The invention has the following advantages and benefits in comparison with the conventional art:

Pin pressure of a pogo pin can be flexibly adjusted. For adjusting the pogo pin selected for adjustment, a user may rotate the adjustment knob to change a pin pressure of the pogo pin. The implementation of the invention can be changed depending on different applications. With various implementations, the user may change a length of the pogo pin projecting out of the pogo pin interface or keep it unchanged. Furthermore, a shield sleeve or a tubular member having shielding effect integrally formed with the knob mounting seat is provided so that an advanced measurement (e.g., very low current measurement or low noise measurement) is made possible.

Change of pogo pins having different diameters is made possible. For replacing the pogo pin with a new one having a different diameter, the user may simply replace the pogo pin with a new one having a different diameter and replace the insulation member with a new one respectively without refurbishing the whole pogo pin interface. This flexibility enables the pogo pin interface to be adaptable to meet the needs of different test applications. Thus, the pogo pin interface is highly practicable.

Increase durability of a pogo pin interface. In an alternative implementation, a bumper spring is provided between the head of each screw and the knob mounting seat. Compression of the bumper spring may absorb shock of the pogo pin interface, thereby decreasing the effect of collision when an object hits the pogo pin interface. As a result, durability of the pogo pin interface is increased.

The above and other objects, features and advantages of the invention will become apparent from the following detailed description taken with the accompanying drawings.

### BRIEF DESCRIPTION OF THE DRAWINGS

FIG. 1 is a perspective view of a pogo pin interface apparatus with pin pressure adjustment device according to a first preferred embodiment of the invention;

FIG. 2 is a longitudinal sectional view of the pogo pin interface apparatus with pin pressure adjustment device;

FIG. 3 is a perspective view of a pogo pin interface apparatus with pin pressure adjustment device according to a second preferred embodiment of the invention;

FIG. 4 is an exploded view of the pogo pin interface apparatus with pin pressure adjustment device of FIG. 3;

FIG. 5 is a longitudinal sectional view of the pogo pin interface apparatus with pin pressure adjustment device of FIG. 3;

FIG. 6 is a perspective view of a pogo pin interface apparatus with pin pressure adjustment device according to a third preferred embodiment of the invention;

FIG. 7 is a longitudinal sectional view of the pogo pin interface apparatus with pin pressure adjustment device of FIG. 6;

FIG. 8 is a perspective view of a pogo pin interface apparatus with pin pressure adjustment device according to a fourth preferred embodiment of the invention;

FIG. 9 is a longitudinal sectional view of the pogo pin interface apparatus with pin pressure adjustment device of FIG. 8;

FIG. 10 is a perspective view of a pogo pin interface apparatus with pin pressure adjustment device according to a fifth preferred embodiment of the invention;

FIG. 11 is a longitudinal sectional view of the pogo pin interface apparatus with pin pressure adjustment device of FIG. 10;

FIG. 12 is a perspective view of a pogo pin interface apparatus with pin pressure adjustment device according to a sixth preferred embodiment of the invention;

FIG. 13 is a longitudinal sectional view of the pogo pin interface apparatus with pin pressure adjustment device of FIG. 12;

FIG. 14 is a view similar to FIG. 13, showing the plungers of the pogo pin having a greater diameter;

FIG. 15 is a perspective view of a pogo pin interface apparatus with pin pressure adjustment device according to a seventh preferred embodiment of the invention;

FIG. 16 is a longitudinal sectional view of the pogo pin interface apparatus with pin pressure adjustment device of FIG. 15;

FIG. 17 is a perspective view of a pogo pin interface apparatus with pin pressure adjustment device according to an eighth preferred embodiment of the invention;

FIG. 18 is a longitudinal sectional view of the pogo pin interface apparatus with pin pressure adjustment device of FIG. 17;

FIG. 19 is a view similar to FIG. 18, showing pogo pin projecting length change resulted from a rotation of the adjustment knob;

FIG. 20 is a perspective view of a pogo pin interface apparatus with pin pressure adjustment device according to a ninth preferred embodiment of the invention;

FIG. 21 is a view similar to FIG. 20, showing pogo pin projecting length change resulted from a rotation of the adjustment knob;

FIG. 22 is a longitudinal sectional view of the pogo pin interface apparatus with pin pressure adjustment device of FIG. 20;

FIG. 23 is a longitudinal sectional view of the pogo pin interface apparatus with pin pressure adjustment device of FIG. 21;

FIG. 24 is a perspective view of a pogo pin interface apparatus with pin pressure adjustment device according to a tenth preferred embodiment of the invention;

FIG. 25 is a longitudinal sectional view of the pogo pin interface apparatus with pin pressure adjustment device of FIG. 24;

FIG. 26 is a view similar to FIG. 25, showing a rotation of both the insulation member and the adjustment knob;

FIG. 27 is a perspective view of a pogo pin interface apparatus with pin pressure adjustment device according to an eleventh preferred embodiment of the invention;

FIG. 28 is a longitudinal sectional view of the pogo pin interface apparatus with pin pressure adjustment device of FIG. 27;

FIG. 29 is a perspective view of a pogo pin interface apparatus with pin pressure adjustment device according to a twelfth preferred embodiment of the invention;

FIG. 30 is a longitudinal sectional view of the pogo pin interface apparatus with pin pressure adjustment device of FIG. 29;

FIG. 31 is an exploded perspective view of a conventional pogo pin interface;

FIG. 32 is an exploded perspective view of another conventional pogo pin interface; and

FIG. 33 is a side elevation of a conventional automatic test system with pogo pin interface and probe card.

### DETAILED DESCRIPTION OF THE INVENTION

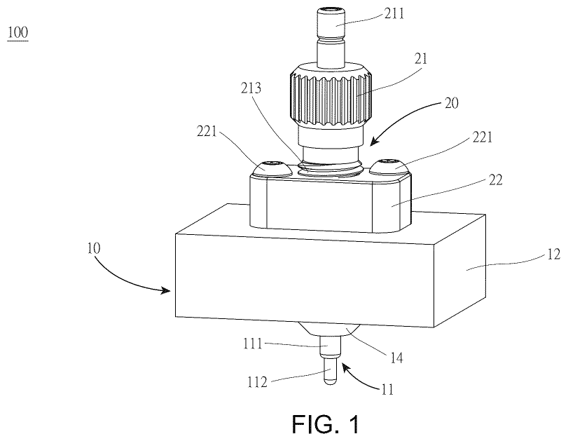

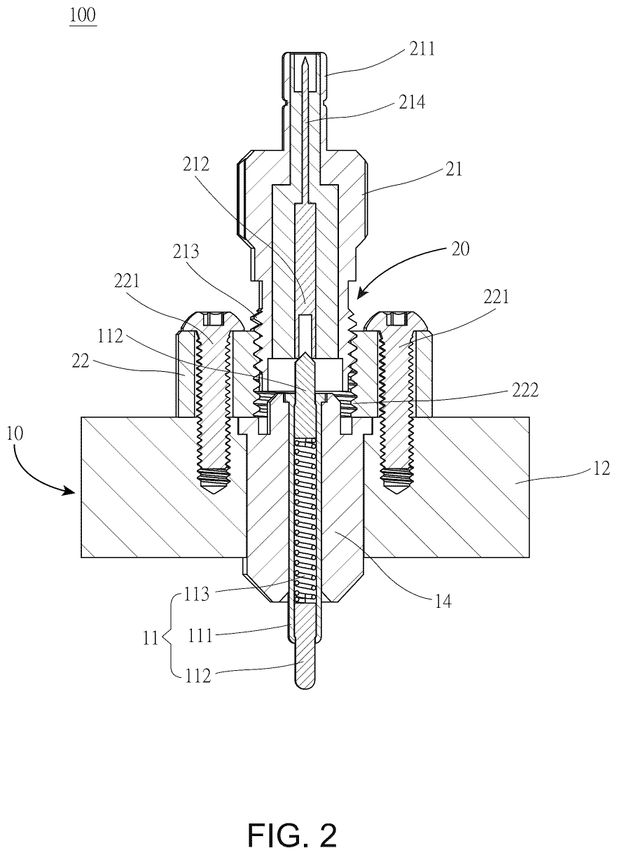

Referring to FIGS. 1 and 2, a pogo pin interface apparatus with pin pressure adjustment device 100 in accordance with a first preferred embodiment of the invention comprises the following components as discussed in detail below.

A pogo pin interface 10 includes a housing 12 and a pogo pin 11. The pogo pin 11 includes a barrel 111 and two plungers 112 at two ends of the barrel 111 respectively. In other embodiments, the pogo pin 11 may include a plunger 112 at only one end. In the embodiment, a helical spring 113 is disposed in the barrel 111, and an insulation member 14 is disposed on the pogo pin 11.

A pin pressure adjustment device 20 is disposed on the housing 12 and includes an adjustment knob 21 and a knob mounting seat 22. The adjustment knob 21 includes a port 211 at one end, a central conductor 214 having one end disposed in the port 211, a contact terminal 212 disposed under the port 211 and electrically connected to the other end of the central conductor 214, and a threaded section 213 formed on an outer surface of the adjustment knob 21 at the other end of the adjustment knob 21. In the embodiment, the knob mounting seat 22 includes two screws 221 for securing the knob mounting seat 22 to one end of the housing 12. In other embodiments, the knob mounting seat 22 and the housing 12 may be fastened together by a means other than the threaded fastening. For example, the knob mounting seat 22 and the housing 12 may be formed integrally. In the embodiment, the knob mounting seat 22 has a threaded hole 222 which is threadedly secured to the threaded section 213. Thus, a user may rotate the adjustment knob 21 to adjust a position of the adjustment knob 21 relative to the knob mounting seat 22. Also, the adjustment can engage the plunger 112 with the contact terminal 212 to electrically connect them together. The contact terminal 212 and the corresponding one end of the pogo pin 11 can have other designs as long as they can achieve the electrical contact. For example, the contact terminal 212 can be implemented as a metal pin, an elastic pin, or a metal piece capable of conducting electricity. Moreover, the port 211 can have other designs as long as it can attach a cable (not shown) to one end of the adjustment knob 21. These implementations other than the ones described in the embodiment are within the spirit and scope of the invention.

The housing 12 is made of insulation material. In the embodiment, both the adjustment knob 21 and the knob mounting seat 22 are made of conductive material (e.g., metal) so that the adjustment knob 21 and the knob mounting seat 22 can be electrically connected together. Thus, they meet the needs of shield in many applications. It is understood that the insulation member 14 can provide good insulation. Thus, in some embodiments, the housing 12 is made of conductive material without causing leakage issues. In some embodiments, the knob mounting seat 22 or the adjustment knob 21 is made of insulation material for reducing weight or some other reasons. The above materials are open for selection as long as the selected material meets the needs of application and the selection is considered optimum. For increasing pin pressure of the pogo pin 11, a user may rotate the adjustment knob 21 to move downward. And in turn, the contact terminal 212 moves downward to push the plunger 112 at one end of the pogo pin 11. Further, the plunger 112 compresses the helical spring 113 which in turn exerts a greater force on the plunger 112 at the other end of the pogo pin 11. As a result, the pin pressure of the pogo pin 11 is increased without changing length of the plunger 112 projecting out of the other end of the pogo pin 11. For replacing the pogo pin 11 with a new one having a different diameter, the user may replace the insulation member 14 with a new one which accommodates the pogo pin 11 having a different diameter. There is no need of the overall replacement of the pogo pin interface 10.

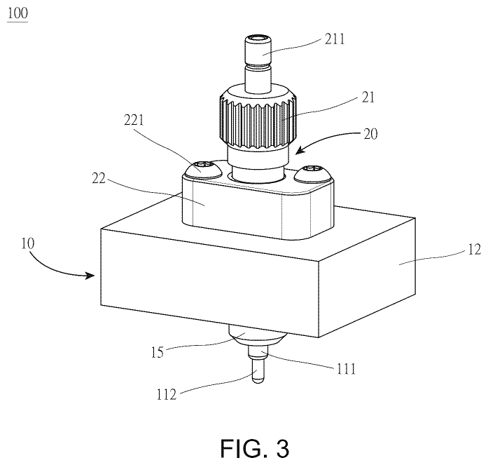

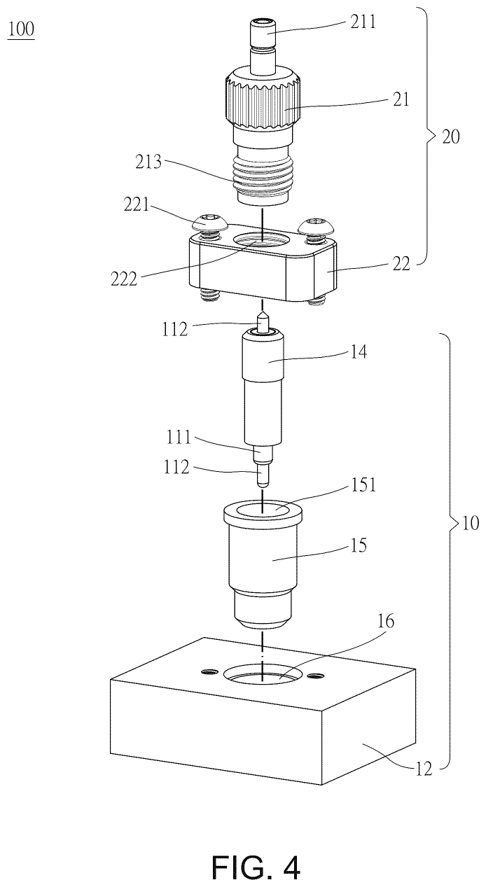

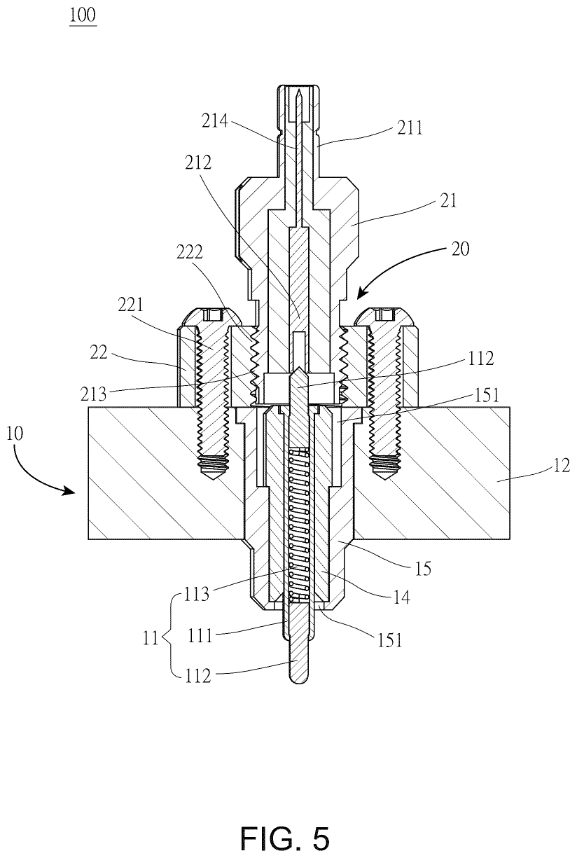

Referring to FIGS. 3 to 5, a pogo pin interface apparatus with pin pressure adjustment device 100 in accordance with a second preferred embodiment of the invention is shown. The characteristics of the second preferred embodiment are substantially the same as that of the first preferred embodiment except the following: a shield sleeve 15 is disposed on the insulation member 14 and has two openings 151 at two ends of the shield sleeve 15 respectively. The opening 151 at one end of the shield sleeve 15 is greater than that at the other end of the shield sleeve 15. The shield sleeve 15 is made of conductive material (e.g., metal). In the embodiment, both the adjustment knob 21 and the knob mounting seat 22 are made of conductive material. The shield sleeve 15 is electrically connected to the knob mounting seat 22 and in turn electrically connected to the adjustment knob 21 indirectly. With the arrangement, the shield sleeve 15 can benefit some special applications (e.g., tests require very low current or very low noise). In these special applications, the electrical connection of the shield sleeve 15 and the adjustment knob 21 can be implemented in a number of arrangements other than the ones described in the embodiment of the invention.

Assembly of the pogo pin interface apparatus with pin pressure adjustment device 100 is detailed below. Firstly, the shield sleeve 15 is disposed in a mounting hole 16 in the housing 12. Next, the pogo pin 11 is disposed through the insulation member 14 which in turn is disposed in the shield sleeve 15. Next, the two screws 221 are driven through the knob mounting seat 22 into one end of the housing 12. Next, the adjustment knob 21 is driven to secure to the threaded hole 222. In such a manner, the user can adjust a depth of a portion of the adjustment knob 21 in the knob mounting seat 22 via rotation of the adjustment knob 21. Thus, the pin pressure of the pogo pin 11 can be adjusted. Finally, a cable (not shown) is attached to one end of the port 211 so as to electrically connect the cable to the pogo pin 11.

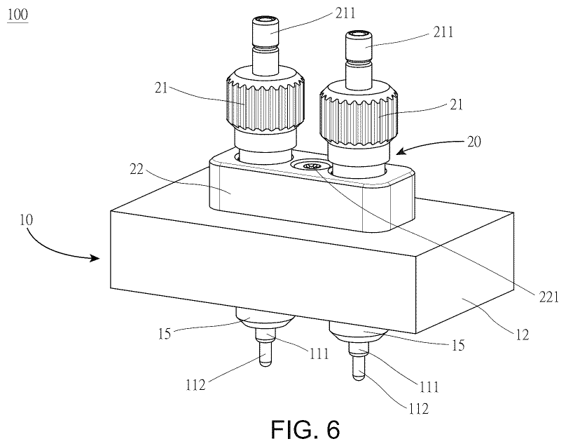

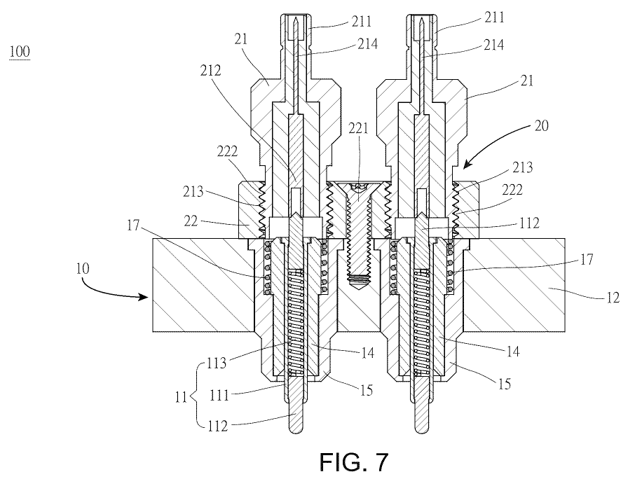

Referring to FIGS. 6 and 7, a pogo pin interface apparatus with pin pressure adjustment device 100 in accordance with a third preferred embodiment of the invention is shown. The characteristics of the third preferred embodiment are substantially the same as that of the second preferred embodiment except the following: the housing 12 includes two pogo pins 11, two insulation members 14, and two shield sleeves 15. The knob mounting seat 22 includes two threaded holes 222 so that two adjustment knobs 21 can be mounted. Both the knob mounting seat 22 and the adjustment knobs 21 are made of conductive material (e.g., metal) so that the adjustment knobs 21 and the knob mounting seat 22 can be electrically connected together. Thus, it meets the needs of shield of signal paths in some tests. Moreover, an auxiliary spring 17 is disposed on each insulation member 14 and in each of the shield sleeves 15. One end of each auxiliary spring 17 urges against the other end of each adjustment knob 21. Both the auxiliary springs 17 and the shield sleeves 15 are made of conductive material (e.g., metal). Further, both the auxiliary springs 17 and the shield sleeves 15 can be plated to reduce contact resistance. With the provision of the auxiliary springs 17, it is possible to enhance the electrical connection of each of the adjustment knobs 21 and the corresponding shield sleeves 15. Elasticity of the auxiliary springs 17 can improve fastening the adjustment knobs 21 that threadedly secured with the knob mounting seat 22.

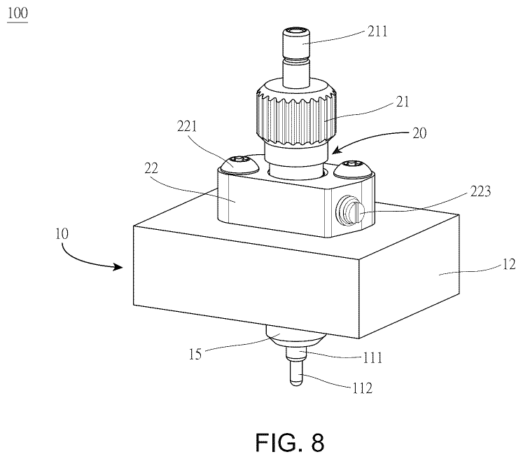

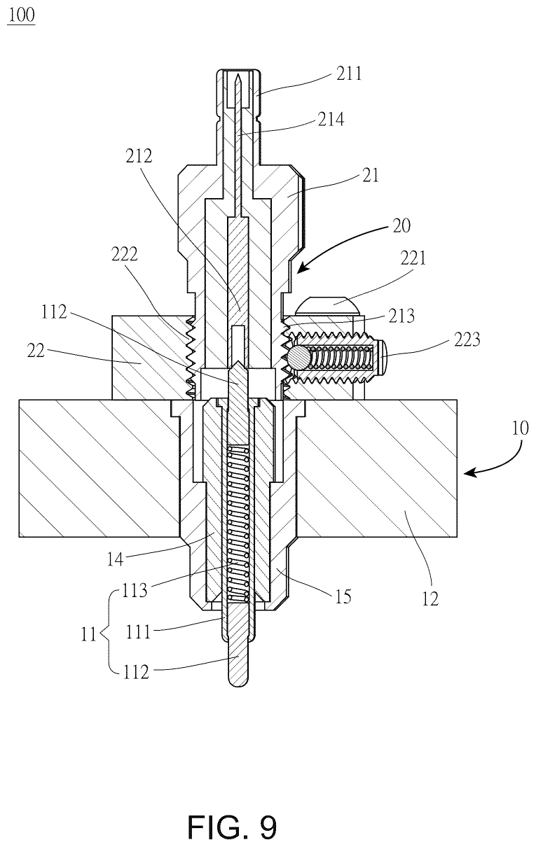

Referring to FIGS. 8 and 9, a pogo pin interface apparatus with pin pressure adjustment device 100 in accordance with a fourth preferred embodiment of the invention is shown. The characteristics of the fourth preferred embodiment are substantially the same as that of the second preferred embodiment except the following: a thread-locking screw 223 is provided at one side of the knob mounting seat 22. The thread-locking screw 223 urges against the threaded section 213 of the adjustment knob 21. The thread-locking screw 223 can prevent the adjustment knob 21 from being rotated accidentally. Otherwise, the pin pressure of the pogo pin 11 may be changed undesirably. Thus, the pin pressure of the pogo pin 11 can be kept securely by the adjustment knob 21. Furthermore, the fastening of the adjustment knob 21 and the knob mounting seat 22 is stable without being compromised by vibration. For adjusting the pin pressure of the pogo pin 11, the user may unfasten the thread-locking screw 223 and rotate the adjustment knob 21 until a desired pin pressure is obtained. Finally, the user may fasten the thread-locking screw 223.

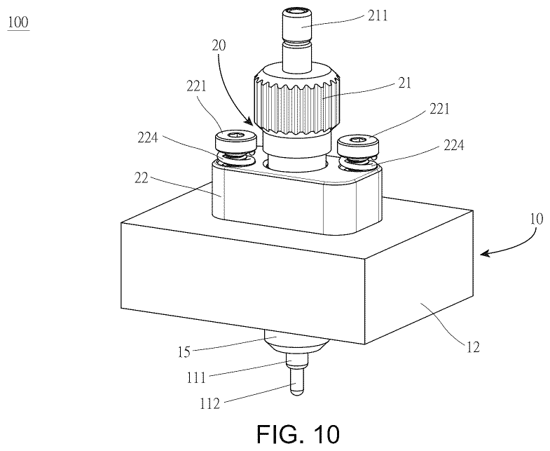

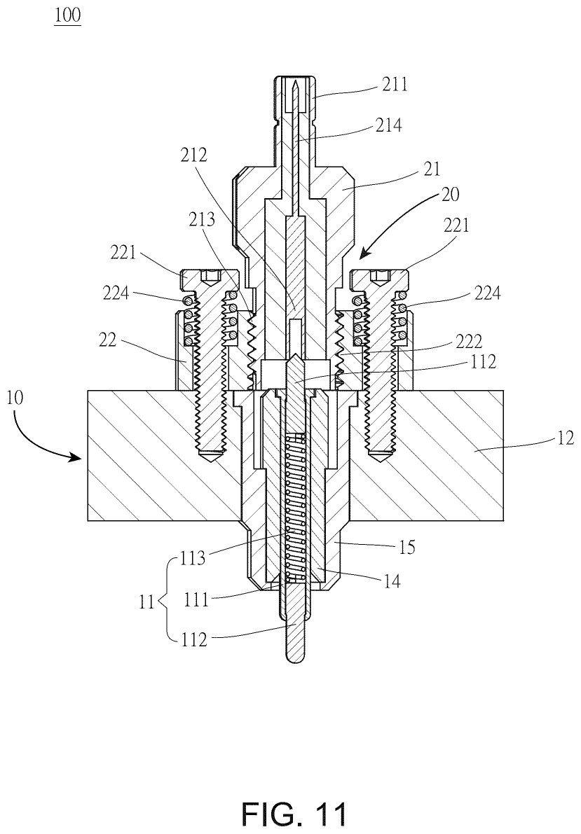

Referring to FIGS. 10 and 11, a pogo pin interface apparatus with pin pressure adjustment device 100 in accordance with a fifth preferred embodiment of the invention is shown. The characteristics of the fifth preferred embodiment are substantially the same as that of the second preferred embodiment except the following: a bumper spring 224 is provided between the head of each screw 221 and the knob mounting seat 22. Compression of the bumper spring 224 may absorb shock of the pogo pin interface 10, thereby decreasing the impact of collision when an object hits the pogo pin interface 10. As a result, probability of the pogo pin interface 10 being damaged is decreased greatly and the pogo pin interface 10 is more durable.

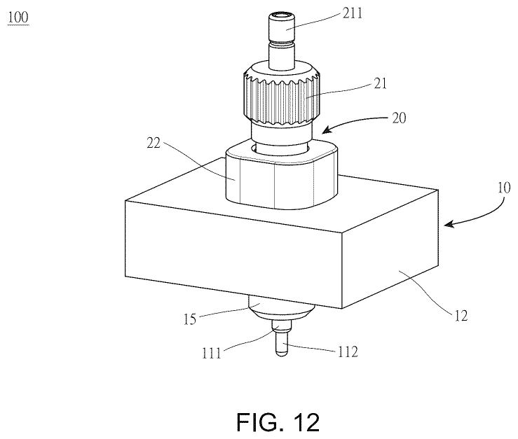

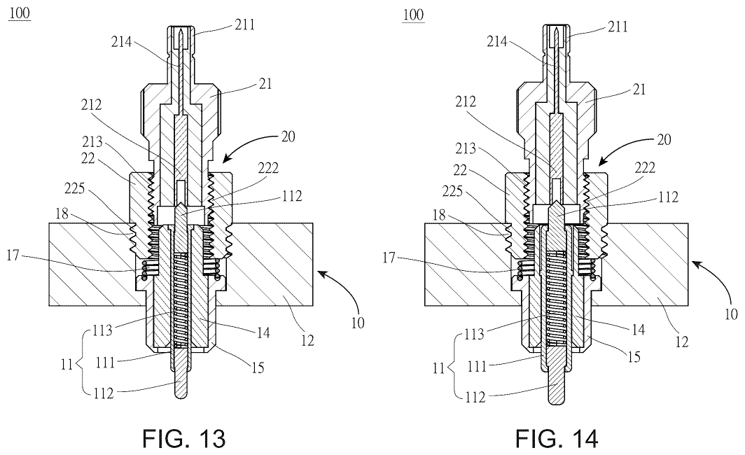

Referring to FIGS. 12 and 13, a pogo pin interface apparatus with pin pressure adjustment device 100 in accordance with a sixth preferred embodiment of the invention is shown. The characteristics of the sixth preferred embodiment are substantially the same as that of the second preferred embodiment except the following: an externally threaded section 225 is provided on the knob mounting seat 22 and adapted to secure to a threaded hole 18 in the housing 12. Thus, the knob mounting seat 22 can be threadedly secured to one end of the housing 12. This eliminates the screw 221 of the second preferred embodiment for fastening. An auxiliary spring 17 as the third preferred embodiment is disposed on the insulation member 14. The auxiliary spring 17 is disposed between the knob mounting seat 22 and the shield sleeve 15. The auxiliary spring 17, the adjustment knob 21, the knob mounting seat 22, and the shield sleeve 15 are made of conductive material (e.g., metal). By bridging the auxiliary spring 17 and the knob mounting seat 22, it is possible to electrically connect the adjustment knob 21 and the shield sleeve 15 together. Signal shielding capability may extend from one end of the adjustment knob 21 to the other end of the shield sleeve 15. As a result, an excellent shielding effect is given.

Referring to FIG. 14 in conjunction with FIGS. 12 and 13, when there is a need of having a pogo pin 11 with a greater diameter in a specific test, the user may replace the pogo pin 11 with an appropriate one and replace the insulation member 14 with a new one which corresponds to the appropriate pogo pin 11. In the embodiment, the pogo pin interface apparatus with pin pressure adjustment device 100 can flexibly adjust the pin pressure of the pogo pin 11 in one aspect and allow the replacement of the pogo pin 11 with a new pogo pin 11 having a different diameter. Thus, the invention is more adaptable to meet the needs of different test applications.

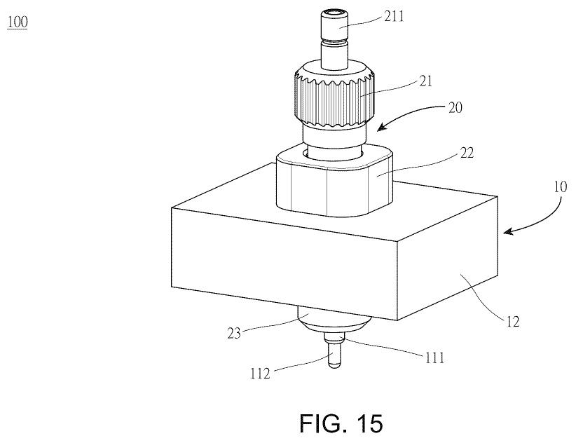

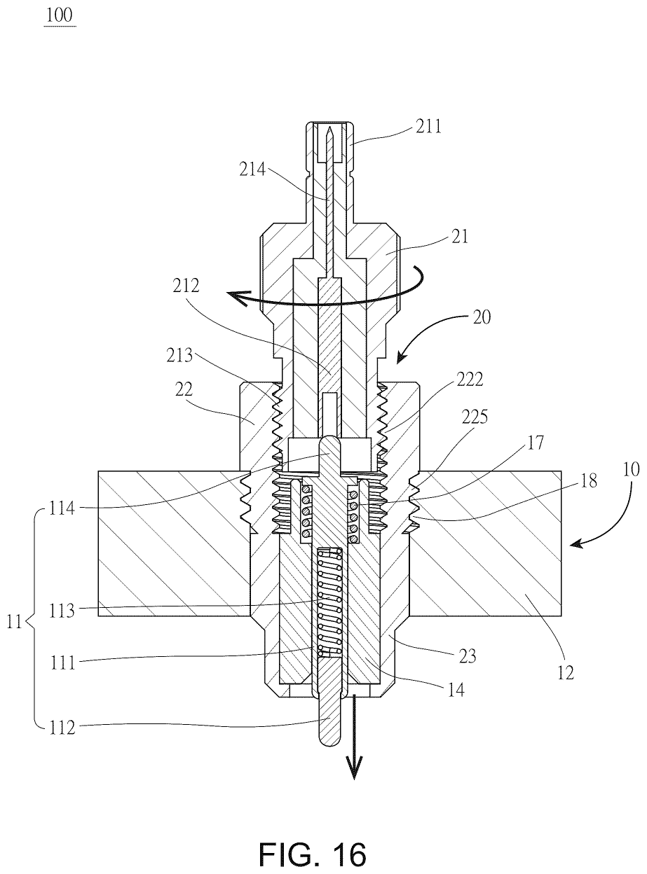

Referring to FIGS. 15 and 16, a pogo pin interface apparatus with pin pressure adjustment device 100 in accordance with a seventh preferred embodiment of the invention is shown. The characteristics of the seventh preferred embodiment are substantially the same as that of the sixth preferred embodiment except the following: a tubular member 23 is integrally formed with the externally threaded section 225 of the knob mounting seat 22 at the other end and partially disposed in the housing 12. The separate knob mounting seat 22 and the shield sleeve 15 in the sixth preferred embodiment are formed as one. The decrease of the components can simplify assembly. In the embodiment, the insulation member 14 is disposed in the tubular member 23 and the auxiliary spring 17 is disposed in the insulation member 14. One end of the pogo pin 11 is provided with a projection member 114. The user can easily operate the pin pressure adjustment device 20 to adjust a projecting length of the pogo pin 11 relative to the housing 12. Therefore, the pogo pin 11 may further project out of the other end of the housing 12 to urge against a probe card (not shown) and increase the contact force (pin pressure) between the pogo pin 11 and the probe card.

The knob mounting seat 22 having an integral tubular member 23 is made of conductive material or insulation material depending on applications. For example, for a test application of measuring a very low current (e.g. 1E-12A) without significant leakage issue, the knob mounting seat 22 having an integral tubular member 23 is made of conductive material. Thus, the tubular member 23 at the other end of the knob mounting seat 22 may give an excellent shielding or guarding effect the same as the shield sleeve 15 of the sixth preferred embodiment. Designed length of the tubular member 23 may be changed depending on application. Thus, the tubular member 23 may be partially or completely disposed in the housing 12.

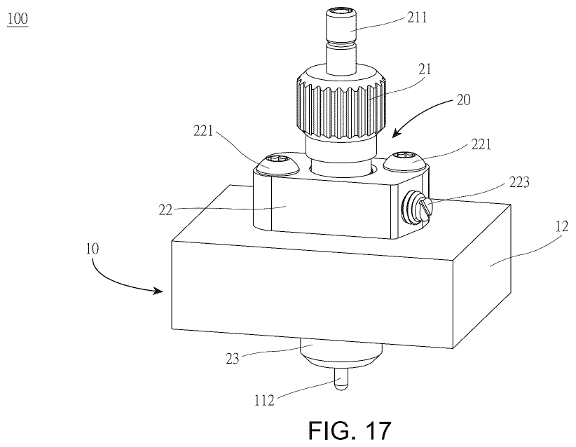

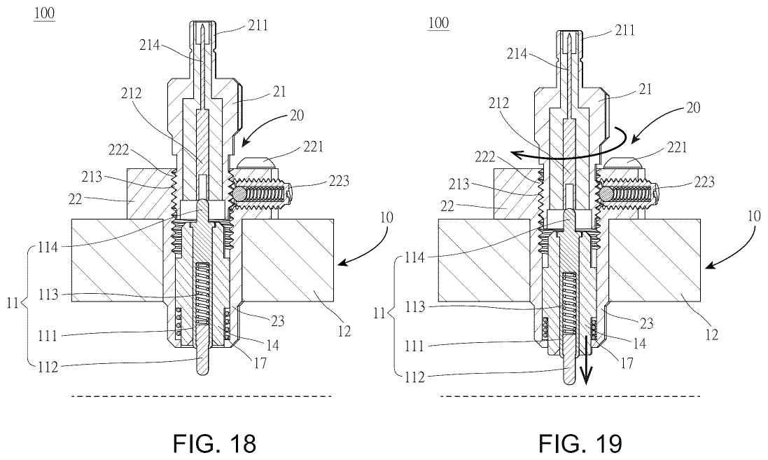

Referring to FIGS. 17 to 19, a pogo pin interface apparatus with pin pressure adjustment device 100 in accordance with an eighth preferred embodiment of the invention is shown. The characteristics of the eighth preferred embodiment are detailed below. It is the same as the seventh preferred embodiment that the knob mounting seat 22 and the tubular member 23 are formed integrally. Also as the seventh preferred embodiment, for decreasing parasite resistance of the pogo pin 11, the plunger at one end of the pogo pin 11 is replaced with a projection member 114. A rotation of the adjustment knob 21 does not compress the helical spring 113 by itself. An auxiliary spring 17 is disposed on a portion of the insulation member 14. Compression of the auxiliary spring 17 may change a projecting length of the insulation member 14 and the other end of the pogo pin 11 (see FIG. 19). The pogo pin 11 may further project out of the other end of the housing 12. Thus, the pogo pin 11 exerts greater force against a probe card (not shown) and increases the pin pressure put thereon. In the embodiment, the thread-locking screw 223 is provided at one side of the knob mounting seat 22. The thread-locking screw 223 urges against the threaded section 213 of the adjustment knob 21. The thread-locking screw 223 can prevent the adjustment knob 21 from being rotated accidentally.

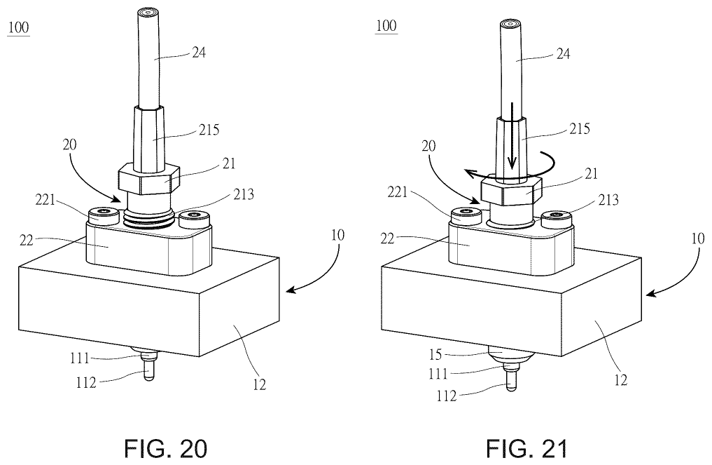

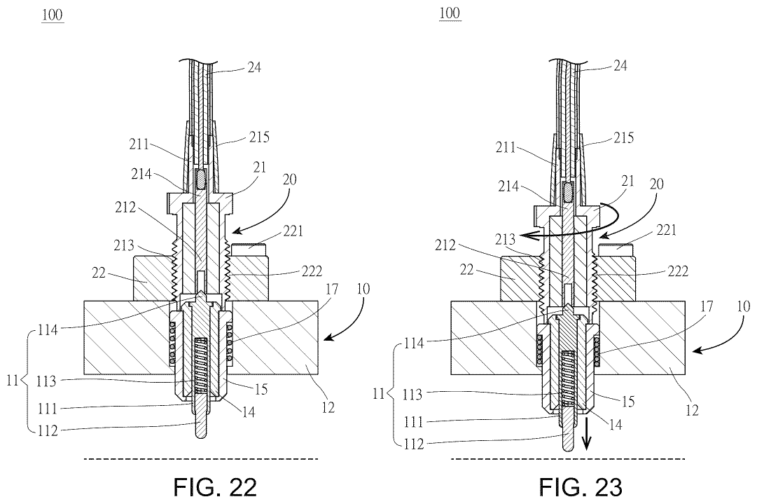

Referring to FIGS. 20 to 23, a pogo pin interface apparatus with pin pressure adjustment device 100 in accordance with a ninth preferred embodiment of the invention is shown. The characteristics of the ninth preferred embodiment are substantially the same as that of the second preferred embodiment except the following: only one plunger 112 is provided at the other end of the pogo pin 11. One end of the pogo pin 11 is provided with a projection member 114 the same as that described in the eighth preferred embodiment. An auxiliary spring 17 is provided in the housing 12 and disposed on the shield sleeve 15 not the same way as that described in the third preferred embodiment which disposes the auxiliary spring 17 in the shield sleeve 15. The adjustment knob 21 contacts the shield sleeve 15 so that they are electrically connected together. Both the auxiliary spring 17 and the helical spring 113 may exert a contact force that secures the electrical connection quality and ensures good signal transmission. Thus, the embodiment is appropriate for precision measurement. In the embodiment, a cable (e.g., co-axial cable) 24 is attached to the port 211. The electrical connection of the cable 24 and the port 211 is achieved by soldering and using a clamp sleeve 215 thereof. It is understood that the electrical connection can be achieved by soldering, pressing, threaded fastening, snapping, screwing or any other equivalent method in a nonlimiting manner.

A rotation of the adjustment knob 21 can further project both the pogo pin 11 and the shield sleeve 15 out of the other end of the housing 12 (see FIG. 23). The pin pressure adjustment device 20 can change lengths of both the pogo pin 11 and the shield sleeve 15 projecting out of the other end of the housing 12. This allows the pogo pin interface 10 to be more adaptable to meet various needs of different test applications.

An additional characteristic of the embodiment is that shape of the adjustment knob 21 is different from that in other embodiments. The adjustment knob 21 is much thinner to prevent it from being interfered by the screws 221, decrease length, decrease weight, and save material if necessary. The shape of the adjustment knob 21 may be different in other arrangements in a nonlimiting manner.

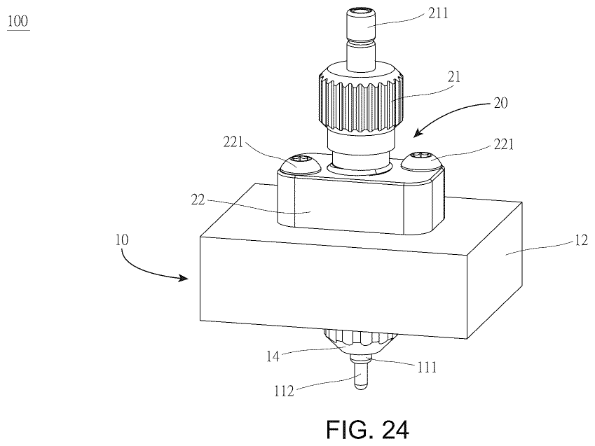

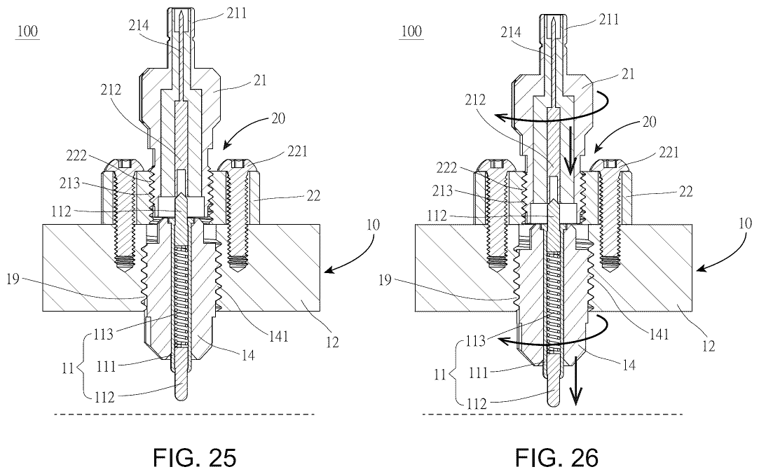

Referring to FIGS. 24 to 26, a pogo pin interface apparatus with pin pressure adjustment device 100 in accordance with a tenth preferred embodiment of the invention is shown. The characteristics of the tenth preferred embodiment are substantially the same as that of the first preferred embodiment except the following: an auxiliary threaded section 141 is formed on an outer surface of the insulation member 14. An auxiliary threaded hole 19 is provided in the housing 12 to allow the auxiliary threaded section 141 to secure thereto. As shown in FIG. 26 specifically, a rotation of the insulation member 14 changes a length of the pogo pin 11 projecting out of the housing 12. With a sufficient rotation of the adjustment knob 21, the contact terminal 212 pushes the plunger 112 at one end of the pogo pin 11. Besides, the insulation member 14 can be removed from the other end of the housing 12 by hand rotation without using a tool to unfasten the screws 221. In such a manner, it is possible to quickly remove the pogo pin 11 for maintenance or replace the pogo pin 11 with a new one having a different diameter or replace the insulation member 14 with a new one to support different pin diameter. This is very convenient.

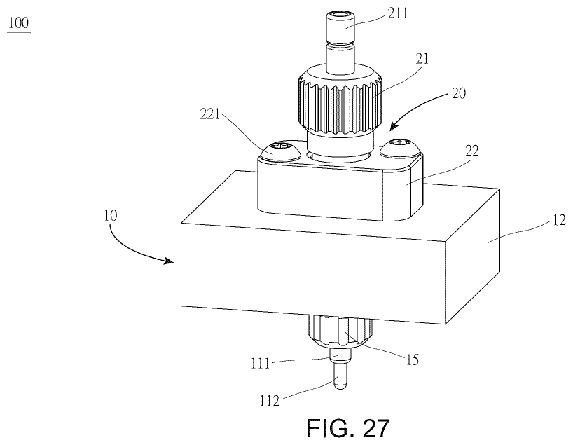

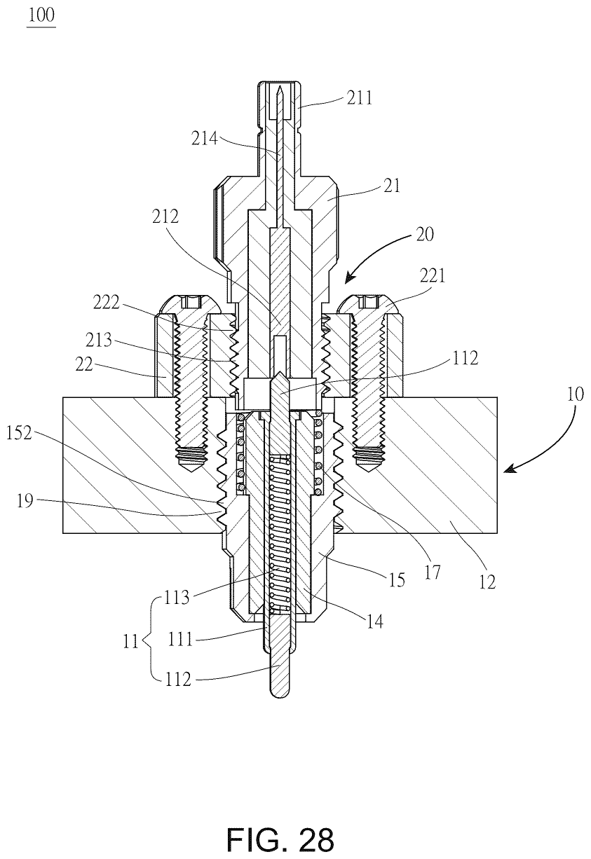

Referring to FIGS. 27 and 28, a pogo pin interface apparatus with pin pressure adjustment device 100 in accordance with an eleventh preferred embodiment of the invention is shown. The characteristics of the eleventh preferred embodiment are substantially the same as that of the second preferred embodiment except the following: an auxiliary threaded section 152 is formed on an outer surface of the shield sleeve 15. An auxiliary threaded hole 19 is provided in the housing 12 the same as that described in the tenth preferred embodiment to allow the auxiliary threaded section 152 to secure thereto. An auxiliary spring 17 is disposed in the shield sleeve 15 and on the insulation member 14 to electrically connect the adjustment knob 21 to the shield sleeve 15. In the embodiment, a rotation of the adjustment knob 21 may compress the helical spring 113 and in turn adjust the pin pressure of the pogo pin 11 in one aspect. A rotation of the shield sleeve 15 may adjust lengths of both the pogo pin 11 and the shield sleeve 15 projecting out of the other end of the housing 12 in the other aspect. This provides a flexible adjustability. A rotation of the shield sleeve 15 can remove itself from the other end of the housing 12. In such a manner, it is possible to quickly remove the pogo pin 11 for repair and maintenance or replace the pogo pin 11 with a new one having a different diameter or replace the insulation member 14 with a new one. This is very convenient.

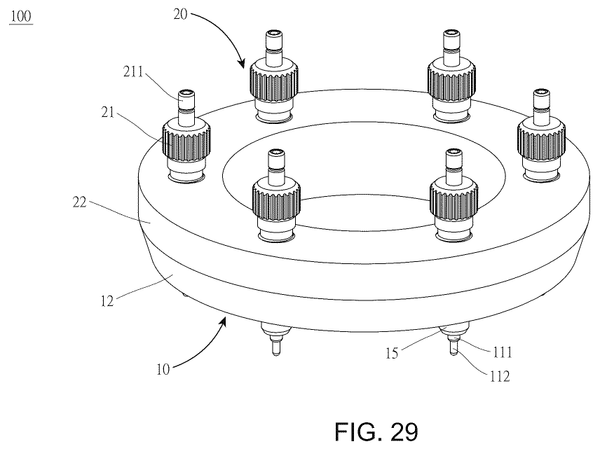

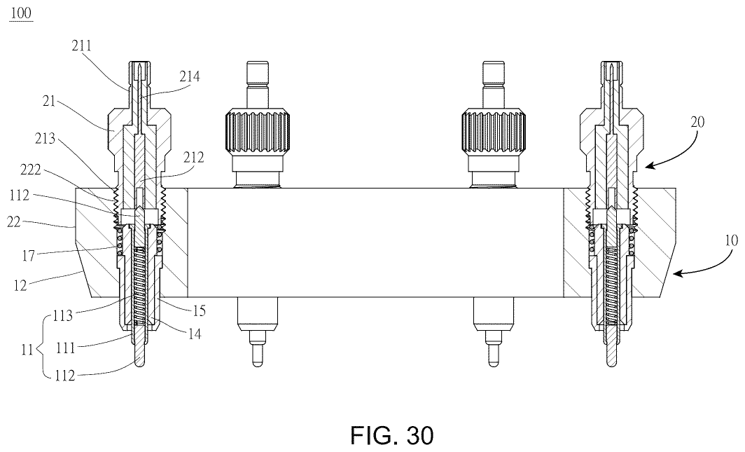

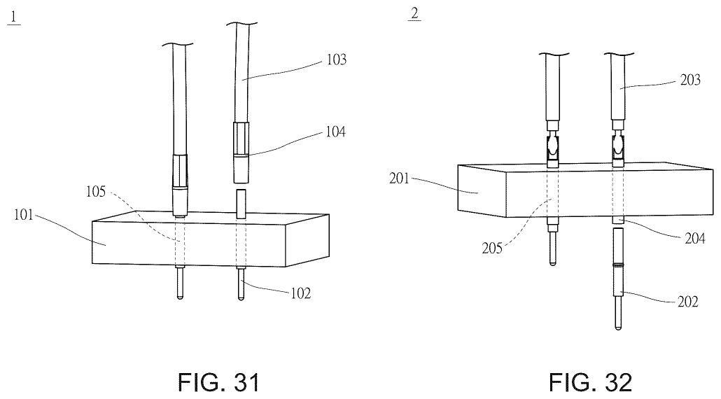

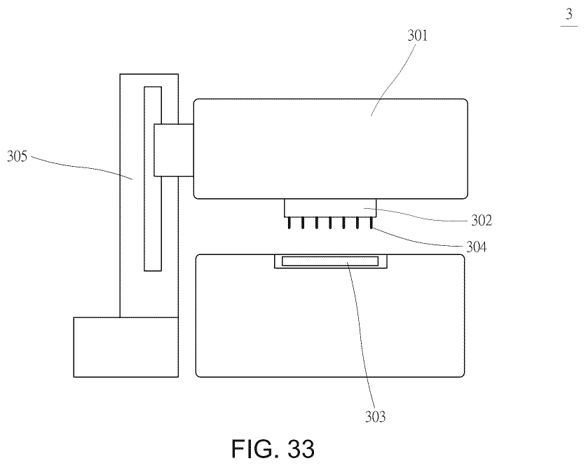

Referring to FIGS. 29 and 30, a pogo pin interface apparatus with pin pressure adjustment device 100 in accordance with a twelfth preferred embodiment of the invention is shown. The characteristics of the twelfth preferred embodiment are substantially the same as that of the third preferred embodiment except the following: both the knob mounting seat 22 and the housing 12 are made of the same material. They are formed integrally, thereby eliminating the screws 221 for fastening. Also, the number of the components is decreased and the assembly is simplified. Furthermore, a plurality of the adjustment knobs 21 can be made more compact if required by applications. In the embodiment, both the knob mounting seat 22 and the housing 12 are annular for meeting the needs of some specific applications. It is understood that the shapes of both the knob mounting seat 22 and the housing 12 in other embodiments can be different from that described in the embodiment in a nonlimiting manner.

While the invention has been described in terms of preferred embodiments, those skilled in the art will recognize that the invention can be practiced with modifications within the spirit and scope of the appended claims.

1. A pogo pin interface apparatus with pin pressure adjustment device, comprising:
a housing;
at least one pogo pin disposed in the housing, a plunger at one end of the pogo pin or either end of the pogo pin, and an insulation member disposed on the pogo pin; and
at least one pin pressure adjustment device disposed on the housing and comprising an adjustment knob including a port at one end, a contact terminal disposed under the port and electrically connected to the port, one end of the pogo pin being in contact with the contact terminal to be electrically connected together, and a threaded section formed on an outer surface of the adjustment knob at the other end of the adjustment knob; and a knob mounting seat comprising at least one threaded hole secured to the threaded section;
wherein a rotation of the adjustment knob is configured to adjust a distance of the adjustment knob relative to the knob mounting seat.

2. The pogo pin interface apparatus with pin pressure adjustment device of claim 1, further comprising a shield sleeve disposed on the insulation member, the shield sleeve having two openings at two ends respectively.

3. The pogo pin interface apparatus with pin pressure adjustment device of claim 1, wherein the knob mounting seat and the housing are formed integrally.

4. The pogo pin interface apparatus with pin pressure adjustment device of claim 1, further comprising an auxiliary spring disposed on the insulation member or in the insulation member.

5. The pogo pin interface apparatus with pin pressure adjustment device of claim 2, further comprising an auxiliary spring disposed on the shield sleeve or in the shield sleeve.

6. The pogo pin interface apparatus with pin pressure adjustment device of claim 1, wherein an electrical connection of the port and a cable is implemented by soldering, pressing, threaded fastening, snapping, or screwing.

7. The pogo pin interface apparatus with pin pressure adjustment device of claim 1, further comprising a thread-locking screw disposed at one side of the knob mounting seat, the thread-locking screw urging against the threaded section of the adjustment knob.

8. The pogo pin interface apparatus with pin pressure adjustment device of claim 1, further comprising at least one screw for securing the knob mounting seat to one end of the housing.

9. The pogo pin interface apparatus with pin pressure adjustment device of claim 8, further comprising a bumper spring disposed between the head of each screw and the knob mounting seat.

10. The pogo pin interface apparatus with pin pressure adjustment device of claim 1, wherein the knob mounting seat comprises an externally threaded section at the other end, and the housing comprises a threaded hole threadedly secured to the externally threaded section of the knob mounting seat so that the knob mounting seat and the housing are fastened together.

11. The pogo pin interface apparatus with pin pressure adjustment device of claim 1, wherein the insulation member comprises an auxiliary threaded section on an outer surface, and the housing comprises an auxiliary threaded hole threadedly secured to the auxiliary threaded section of the insulation member.

12. The pogo pin interface apparatus with pin pressure adjustment device of claim 2, wherein the shield sleeve comprises an auxiliary threaded section on an outer surface, and the housing comprises an auxiliary threaded hole threadedly secured to the auxiliary threaded section of the shield sleeve.

13. A pogo pin interface apparatus with pin pressure adjustment device, comprising:
a housing;
at least one pogo pin disposed in the housing, a plunger at one end of the pogo pin or either end of the pogo pin, and an insulation member disposed on the pogo pin; and
at least one pin pressure adjustment device disposed on the housing and comprising an adjustment knob including a port at one end, a contact terminal disposed under the port and electrically connected to the port, one end of the pogo pin being in contact with the contact terminal to be electrically connected together, and a threaded section formed on an outer surface of the adjustment knob at the other end of the adjustment knob; and a knob mounting seat comprising an integral tubular member which is at least partially disposed in the housing, and at least one threaded hole;
wherein the insulation member is disposed in the tubular member through the threaded hole which is threadedly secured to the threaded section; and
wherein a rotation of the adjustment knob is configured to adjust a distance of the adjustment knob relative to the knob mounting seat.

14. The pogo pin interface apparatus with pin pressure adjustment device of claim 13, further comprising an auxiliary spring disposed on the insulation member or in the insulation member.

15. The pogo pin interface apparatus with pin pressure adjustment device of claim 13, further comprising a thread-locking screw disposed at one side of the knob mounting seat, the thread-locking screw urging against the threaded section of the adjustment knob.

16. The pogo pin interface apparatus with pin pressure adjustment device of claim 13, further comprising at least one screw for securing the knob mounting seat to one end of the housing.

17. The pogo pin interface apparatus with pin pressure adjustment device of claim 16, further comprising a bumper spring disposed between the head of each screw and the knob mounting seat.

18. The pogo pin interface apparatus with pin pressure adjustment device of claim 13, wherein the knob mounting seat comprises an externally threaded section at the other end, and the housing comprises a threaded hole threadedly secured to the externally threaded section of the knob mounting seat so that the knob mounting seat and the housing are fastened together.

19. The pogo pin interface apparatus with pin pressure adjustment device of claim 13, wherein an electrical connection of the port and a cable is implemented by soldering, pressing, threaded fastening, snapping, or screwing.
